(19) United States
(12) Patent Application Publication
(10) Pub. No.: US 2005/0109181 A1
(43) Pub. Date: May 26, 2005

(54) Coping jig

(76) Inventors: Antoni Zawadzki, Buffalo, NY (US); Jeffrey Mercuri, Depew, NY (US)

Correspondence Address: PATRICIA M. COSTANZO, PATENT COPYRIGHT TRADEMARK LAW, 2960 BOWEN ROAD, ELMA, NY, 14059, US

(21) Appl. No.: 10/720,497

(22) Filed: Nov. 24, 2003

(51) Int. Cl. B27G 5/02; B27C 5/00

(52) U.S. Cl. 83/565; 83/413; 83/471.2; 144/144.1; 144/135.2; 144/372

(57) ABSTRACT

A coping jig for coping molding to a predetermined shape, comprising a base having a first surface area adapted to receive a cutting means and a section of molding and a second surface area to receive a template. There is at least one clamping means for releasably securing a work piece on the base and a template holding means adapted for the detachable attachment of a template thereto wherein the direction of movement of the cutting means guided by the template is transferred to the direction of movement of a cutting member of the cutting means, thereby cutting said work piece to conform to said predetermined shape. The coping jig is adapted for receiving a jig saw, a hole saw, and a router to cope 2¼ in., 3¼ in., and quarter round molding. The coping jig may be made of plastic by molding to be extremely lightweight and portable.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to an apparatus for cutting a work piece and more particularly to a jig for coping molding.

The background information discussed below is presented to better illustrate the novelty and usefulness of the present invention. This background information is not admitted prior art.

Decorative molding is used extensively by both non-professional and professional carpenters as finishing base trim that is installed on walls adjacent to a floor or as chair rail trim that is placed on walls somewhere about midway between floor and ceiling. Base molding that is affixed to a wall adjacent to the floor is called baseboard molding when referring to moldings that are on the order of two to three inches wide or as shoe molding or quarter round when the molding is typically about an inch or less in width. Finishing molding, typically, has a simple curved profile that forms an aesthetically pleasing design for the molding. This type of molding is the most commonly used and thus is in great demand and is usually in plentiful supply. The fact that molding exhibits a simple curve, however, does not imply that installing this molding is simple.

Each corner of a room that is to be fitted with molding requires one piece of molding that is to be affixed to one wall to be fitted against or next to a second piece of molding that is to be affixed to another wall where the two walls typically form right angle to each other. Merely cutting the molding ends at a 45° angle does not form a clean corner due to the curved profile of typical decorative molding. Precisely fitting the two ends of two sections of molding that meet at an inside corner of a room requires the skill of a finishing carpenter. The process of obtaining a precise fit between the nds of two pieces of molding is called coping.

Coping is defined as the process whereby the end surface of one piece of molding is shaped to seat flushly against the face of another piece of molding ensuring that the ends of the two pieces of molding fit together exactly. Coping molding is a demanding and time-consuming practice that requires a high degree of skill. In general, the first step in coping a piece of molding requires creating a pattern of a negative image of the outer face profile of the molding. Then using the pattern as a guide the end of a piece of molding is cut so that the cut end has the negative profile of the curved outer face of the molding. Traditionally coping is accomplished by a finishing carpenter who must hand-carve each piece of molding or use a coping saw to form a negative coped image of the profile of a curved surface face of the molding. Once the negative image has been coped on the end of the piece of molding, that coped piece of molding is ready is to be fit against the curved surface face of a complementary piece of molding that is already affixed to one wall.

It would be a rare event for the coped end of molding to fit precisely against the curved surface face of the complementary piece of molding after the first coping. It is routinely expected that each corner of each room that is to receive coped molding will require a multi-stepped process of coping each end of molding before the required exact negative image of the outer face profile of the molding is achieved on the coped end of molding. This process requires fitting a piece of coped molding to the of molding already affixed to a wall and, then, repeating as often as required, a repeat check for fit, and as necessary, modifying the molding one or more times until the corner fit between the first and second section of molding is acceptable. Thus, it is obvious that coping molding requires exacting skills from non-professional home carpenters and from a labor force that consists mainly of unskilled laborers and rough-finish carpenters. In a large house requiring a substantial amount of molding this process can significantly increase the amount of time required to fully trim a house with decorative molding.

It is clear that what is missing from the art of woodworking is a coping jig that easily and effortlessly shapes the ends of sections of work pieces such as molding so that the shaped, i.e. coped molding fits directly over a section of molding already in place and where that coping jig produces accurate results, is lightweight, of convenient size, affordable to both make and own, and is easy to operate.

There have been some attempts to provide for a device that will allow molding to be coped without having to resort to the tedious hand-work methods of shaping molding ends using negative patterns as a guide. Each of these attempts, however, requires complex multi-pieced devices that are bulky and heavy making transporting these devices from one job site to another or even from one work area to another burdensome and time consuming. Other endeavors require that the complex and weighty device to be independently mounted to and supported by a work table or a sturdy support surface in order to operate the device. Additionally, some of these devices require a dedicated motor unit to drive either a vibrating or oscillatory blade, where such blades are part of the device.

It is clear that what is missing from the art of woodworking is a lightweight, easily mobile coping jig of simple construction that provides for the nearly effortless shaping of the ends of sections of molding to fit directly over molding already in place. This need is perhaps more easily understood, when one reviews how window trim molding is currently fitted to the inside of a window frame. Firstly, two long sections of finishing molding are prepared for fitting along the inside of the two long sides of a window frame. The ends of the two long sections of molding are “straight cut”, that is the ends are cut parallel to the horizontal top and bottom pieces of the window frame so that once the molding sections are precisely the length and shape required for positioning along the inside of the two long vertically oriented sides of the window frame. Once the two prepared sections of molding are affixed to the inside of the window frame, a short section of molding, to be placed horizontally at the top of the window frame between the previously fitted two long molding sections, must be prepared. That is, the ends of the short piece of molding must be coped, by hand-carving or by using a coping saw, using a previously prepared pattern as described above. The piece must then be fitted and re-coped as many time as necessary until the short section can be placed between the top ends of the fitted long molding sections With it ends fitting snugly and precisely over the top ends of the long molding sections. This is a labor-intensive, time consuming process adding significantly to the cost of a home or of any other structure where finishing molding is desired. Thus, if there were a portable coping jig that could quickly, efficiently, precisely, and easily cope the ends of the work pieces, such as trim moldings, the requirement of repeated hand shaping and angling of the ends would be eliminated, efficiency, precision, and economy would improve, and costs would diminish.

### SUMMARY

Accordingly, the present invention discloses a novel coping jig for coping the ends of molding without the use of a pattern or repeated trials and errors. The affordable, lightweight, portable coping jig as described herein provides for the precise, one-pass coping of molding to be easily accomplished in a matter of moments, completely eliminating the need for any hand shaping and for any repeated fitting procedures, as discussed above. The jig, as described herein, dramatically reduces the time and effort involved in coping molding while increasing efficiency, precision, and economy. Each cut takes literally only a matter of moments. If, as in the embodiment described, the coping jig is molded from a lightweight material such as plastic or fiberglass, it weighs only a few pounds making it readily portable.

In particular, the invention is a coping jig for use in woodworking. The jig comprises a template for guiding the cutting tool of a jig saw, hole saw, or router for the purpose of simultaneously cutting and precisely shaping the end of a work piece, such as decorative trim or molding, so that two sections of molding can be fitted to form an inside corner join in literally a only matter of minutes by professional and non-professional carpenters.

The coping jig of the present invention comprises a base having a first surface area which serves to define an opening for the operation of a cutting member of a cutting means, as a work area to receive a work piece to be coped, and as a support for clamping means for releasably securing a work piece on the base during the cutting process. A second surface area of the base is adapted to function as a template holding stage to hold at least one template having at least one template pattern formed on an dge of the template. The at least one template guides a saw or router along a cutting path so that an end of a piece of molding is shaped to a desired contour for its use as a corner piece. Each template is reversibly mounted onto the template holding stage by at least one clamping member(s). The clamping member(s) allow for the easy and rapid clamping and unclamping of a template.

The present invention achieves the above and more by providing:
a coping jig for cutting the end of a work piece in a configuration conforming to a predetermined shape, comprising:
a base, comprising:
   i) a first surface area defining a work area adapted to receive a work piece, the cutting member of a cutting means, and means for reversibly securing the work piece during the cutting procedure;
   ii) a second surface area adapted to receive a template holding
means and a template;
   wherein the template holding means is operable for the detachable attachment of a template thereto, wherein the direction of movement of the cutting means guided by the template is transferred to the direction of movement of a cutting blade of the cutting means, thereby cutting the work piece to conform to the predetermined shape.

The coping jig wherein said clamping means for securing a work piece on the work area of the base, further comprises:
a) a first clamping means, and
b) a stopper edge;
wherein the first clamping means is slidably attached to the first surface area of the base;
wherein the stopper edge is defined by the junction between the first base surface area and the second base surface area, wherein the first clamping means and the stopper edge are oppositely disposed to each other at opposite lateral sides of the work area to cooperatively securely position differently sized work pieces on the work area.

Furthermore wherein the clamping means for securing a work piece on the work area of the base further comprises:
a second clamping means rotably attached to the second base surface area and adapted for securing the work piece in a vertical direction.

The cutting means to be used in conjunction with the coping jig may be a jig saw, a hole saw, or a router.

The coping jig may be made by a molding technique using a suitable material, such as a durable plastic, if a lightweight, portable jig is desired. The coping jig also may be made of wood and be provided in the form of a kit for self-assembly. Alternative, if desired, the jig can be made from any suitable metal or metal alloy or from a material such as fiber glass.

The base of the coping jig has means for attaching the jig to a table top or other support surface, if such attachment is desired.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings depict only one preferred embodiment of the present invention and are not therefore to be considered limiting in scope. The invention will now be described and explained with added specificity and detail through the use of the accompanying drawings, in which:

FIG. 1 is a perspective top view of a preferred embodiment of the coping jig of the present invention illustrating the base of the jig.

FIG. 2 is a perspective top view of the coping jig illustrating two work piece clamping means and a template affixed to the base, as shown in FIG. 1.

FIG. 3 is a top plan view of the coping jig, as shown in FIG. 2, illustrating a piece of molding on the work area and the position of, in dashed lines, the jig saw feet and jig saw blade, in a position for coping the molding according to the predetermined shape of the template. Note that for clarity of understanding som of the drawing lines are separated by a small distance from other drawing lines, where when in actual use the saw blades would be directly adjacent to the template, the work piece (i.e., the molding) would be held firmly and closely by the clamping means, and the work piece would abut the template.

FIG. 4a is a plan view of a template used by the present invention for cutting 2¼ inch molding.

FIG. 4b is a plan view of a template used by the present invention for cutting 3¼ inch molding.

FIG. 4c is a perspective view of a coping piece of molding being fitted against another section of the same type of molding.

FIG. 5 is a top plan view of the working surface of the present invention to illustrate the circularly-shaped opening 100 to accommodate a hole saw for the coping of a section of quarter-round molding 72.

FIGS. 6a and 6b are perspective views of quarter-round moldings showing one piece of molding coped to fit precisely over a second piece of molding.

A list of aspects of the embodiment of the invention described to which the following reference numbers refer.
8 A work area.
10 The coping jig of the present invention.
12 Base of coping jig 10 having a work area.
14 A first surface area of coping jig base 12 for supporting a work piece and second clamping means 54 for securing position of work piece during a cutting procedure.
16 A second surface area of coping jig base 12 for supporting template 40 and first clamping means 52.
18 First aperture that in the described embodiment is used as a hole for a fastening means.
20 Stopper edge used for positioning work piece.
22 Clearance slot for cutting tool.
24 Stop washer to protect coping jig surface.
26 Bushing to maintain radius of first aperture 28.
28 First aperture with a radius.
30a First locator pin used in the described embodiment to hold and secure position of template 40.
30b Second locator pin used in the described embodiment to hold and secure position of template 40.
32 Second aperture that in the described embodiment is used as a hole for a fastening means.
34a First clamping means for clamping coping jig base 12 to a supporting surface, if desired.
34b Second clamping means for clamping coping jig base 12 to a supporting surface, if desired.
36 Third aperture that in the described embodiment is used as a hole for a fastening means.
38a A first groove.
38b A second groove.
40 A first template that according to the described embodiment is shaped according to 2¼ inch molding.
40a Molding trim pattern formed along an edge surface of 40.
42 Second template that according to the described embodiment is shaped according to 3¼ inch molding.
44a A first aperture of template 40 used according to the described embodiment in conjunction with first locator pin 30a to hold and secure position of template on second surface 16.
44b A second aperture of template 40 used according to the described embodiment in conjunction with second locator pin 30b to hold and secure position of template on second surface 16.
46 An aperture in first template 40 which according to the described embodiment is used as a hole for a fastening means.
48a A first aperture of template 42 used according to the described embodiment in conjunction with locator pin 30a to hold and secure position of template on second surface 16.
48b A second aperture of template 42 used according to the described embodiment in conjunction with locator pin 30b to hold and secure position of template on second surface 16.
50 An aperture in second template 42 which according to the described embodiment is used as a hole for a fastening means.
52 First clamping means for securing position of work piece during a cutting procedure.
54 Second clamping means for securing position of work piece during a cutting procedure.
60 Slot for positioning second clamping means.
64 Wing nut for securing second clamping means 54.
66 Wing nut for securing first clamping means 52.
68 Wing nut for securing template 40.
70 A work piece such as a section of 2¼ inch molding, for example.
90 An outline in dashed lines of the base of a jig saw.
94 An outline in dashed lines of a blade of a jig saw.
100 Hole saw receiving area.
102 First section of quarter-round molding.
104 Second section of quarter-round molding before coping.
104a Second section of quarter-round molding after coping to fit over section 102.
140 A section of uncoped molding.
140a A section of molding coped to be fitted to 140.

It should be understood that the drawings are not necessarily to scale, for instance, depending on the method of manufacture the size of the clamping means may vary, if fact there are other clamping means designs that would hold a work piece firmly in position for cutting and still be within the teachings of the invention. Additionally the openings through which a cutting member, such as a jig saw blade, for example, may extend may be of various sizes and shapes. In certain instances, details which are not necessary for an understanding of the present invention, or which render other details difficult to perceive, may have been omitted.

### DETAILED DESCRIPTION

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

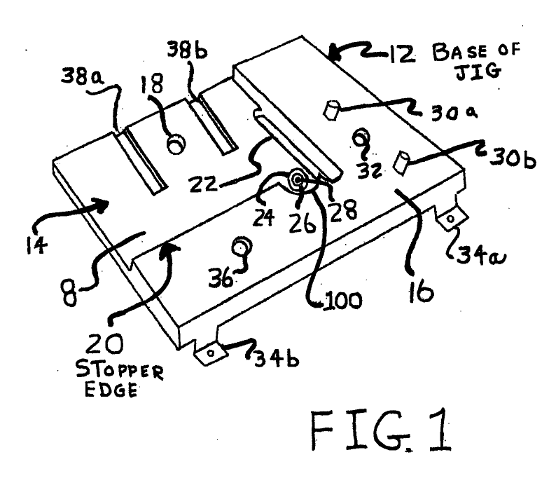

The present invention is directed towards a novel, lightweight, portable, easy to use, and affordable coping jig. Turning now to the drawings where one exemplary preferred embodiment of the present invention is illustrated, FIG. 1 shows coping jig 10 comprising a unitary stationary base 12. In the embodiment shown, base 12 is manufactured as a unitary molded piece preferably out of a light weight, but sturdy material. However, if desired, base 12 may also be constructed from wood, metal, or fiberglass. A portion of the generally flat, horizontal first surface area 14 of the stationary base defines work area 8 adapted to receive a work piece. Another portion of the first surface area 14 adjacent to work area 8 is adapted to receive means for positioning and clamping a work piece to work area 8. To this end, grooves 38a and 38b are adapted to receive a clamp means for secure positioning of the clamp means on surface 14. Aperture 18 is adapted for securing a clamp to first surface area 14 of base 12. Yet still another portion of surface area 14 defines clearance slot 22 to receive a cutting member of a cutting tool, such as the blade of a jig saw, for example.

Proximate to slot 22 is hole saw receiving area 100 notched into second surface area 16 of base 12. At the base of the notch, on surface 14 is aperture 28 with a radius. Aperture 28 is adapted to receive the cutting member of a hole saw cutting means. Stop washer 24 is placed over the surface area proximate to aperture 18 to protect surface 14 from wear damage that could be caused from the cutting member. Bushing 26 maintains the integrity of the radius of aperture 28.

Second surface area 16 additionally comprises at least one template holding means, which in the embodiment illustrated consists of two locator pins 30a and 39b and aperture 32 that are to be used in conjunction with corresponding parts on a template.

Attached to base 12 are mounting brackets 34a and 34b for mounting the coping jig to a supporting surface, if desired. Corresponding brackets (not shown) are positioned on the opposite side of base 12.

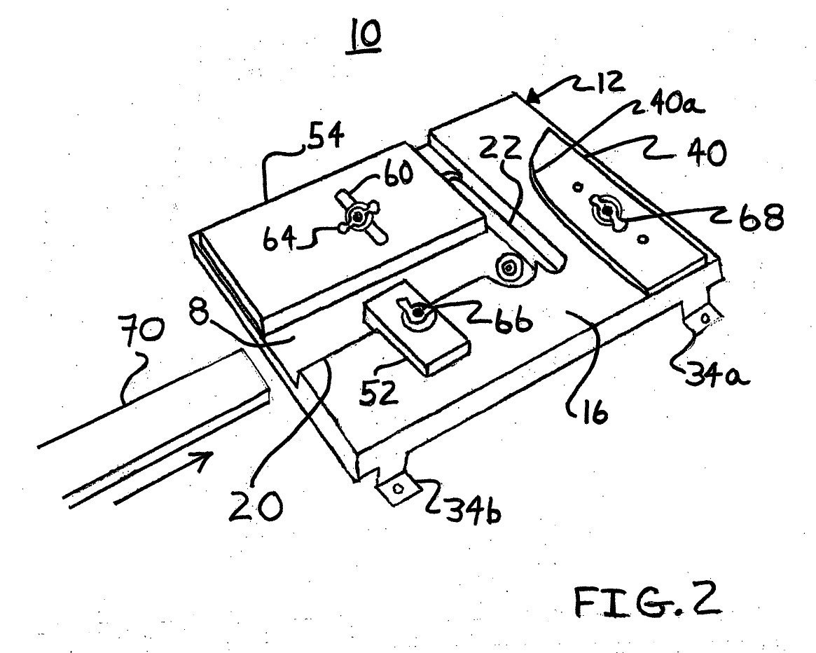

FIG. 2 illustrates coping jig 10 arranged for use with template 40 operatively attached to surface area 16 using template holding means described above. Template 40 includes at least one decorative molding trim pattern formed along an edge surface. After work piece 70, such as a section of 2¼ inch base molding, for example, is reversibly and securely positioned on work area 8, the motion of a cutting means of choice is guided along the trim pattern edge surface of the template providing for the pattern of the template to be transferred to the motion of the cutting member of the cutting means transferring the pattern on the template to the cut end of the section of molding. Once an end of a molding is cut, the other end of the molding is cut by simply turning the molding over to trim the uncut end.

Each of the templates is removable from the template platform and can be replaced by a template having a different pattern. The templates used to create the end cuts in a section of molding include a pair of edge surfaces that may each include a separate trim pattern. In this manner, a single template can be used to create an end cut on multiple types of decorative molding. The templates are reusable and given reasonable care should last for the life time of the device.

FIG. 2 illustrates one method of positioning and securely clamping a work piece on the work area of the jig base wherein said first clamping means 54 is slidably attached to said first surface area of said base. Two ridges (not shown) operatively positioned on the back of first clamping means 54 fit into grooves 38a and 38b for the laterally secure positioning of clamping means 54 to first surface area 14 of base 12. Opening 60 is adapted for the slideable positioning of clamping means 54 at various distances from stopper edge 20. Clamping means 54 and stopper edge 20 are oppositely disposed at opposite lateral sides of said work area 8 to cooperatively securely position differently sized work pieces on the work area for cutting. Clamping means 52 is rotably attached to surface area 16 by securing means 66 securing the work piece in the vertical direction.

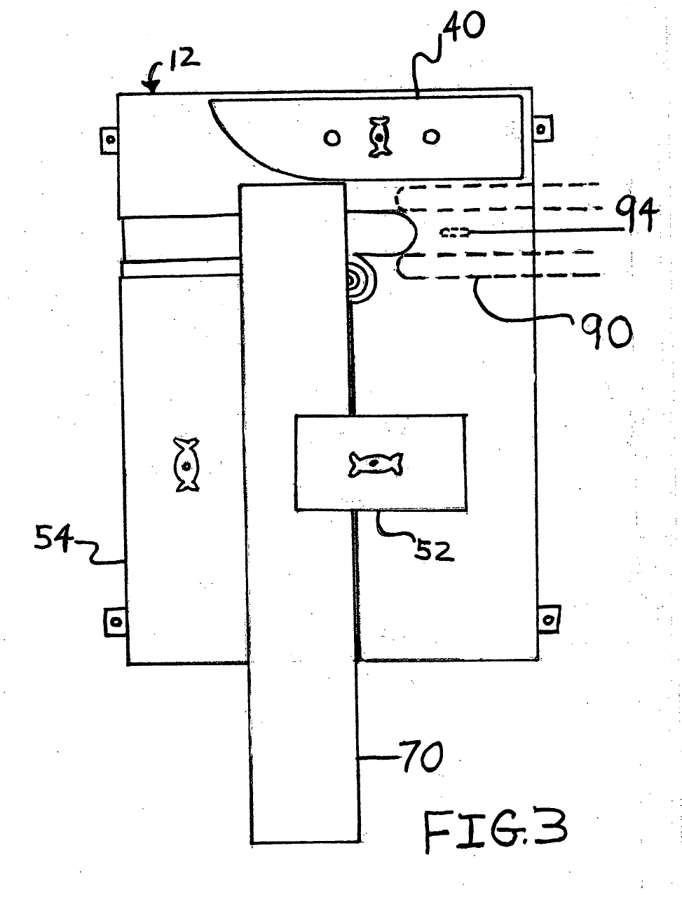

FIG. 3, a plan view looking down onto the top surfaces of the jig, illustrates the position of a cutting means, such as the feet of a jig saw and the saw blade, for example, relative to the patterned side of template 40 and to work piece 70.

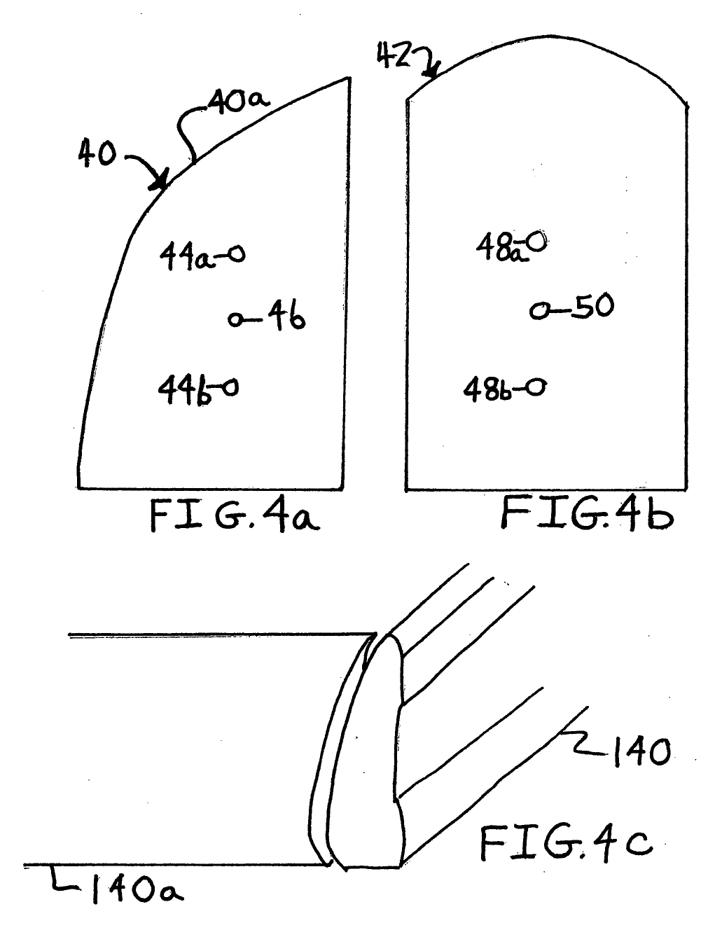

Two of the most popular trim base moldings are the 2¼ inch and the 3¼ inch moldings. FIGS. 4a and 4b illustrate, using plan views, template 40 patterned for coping 2¼ inch molding and template 42 patterned for coping 3¼ inch molding. FIG. 4c illustrates, using a perspective view, a non-coped section of 2¼ inch molding 140 unto the surface of which coped section of 2¼ inch molding 140a is to be fitted.

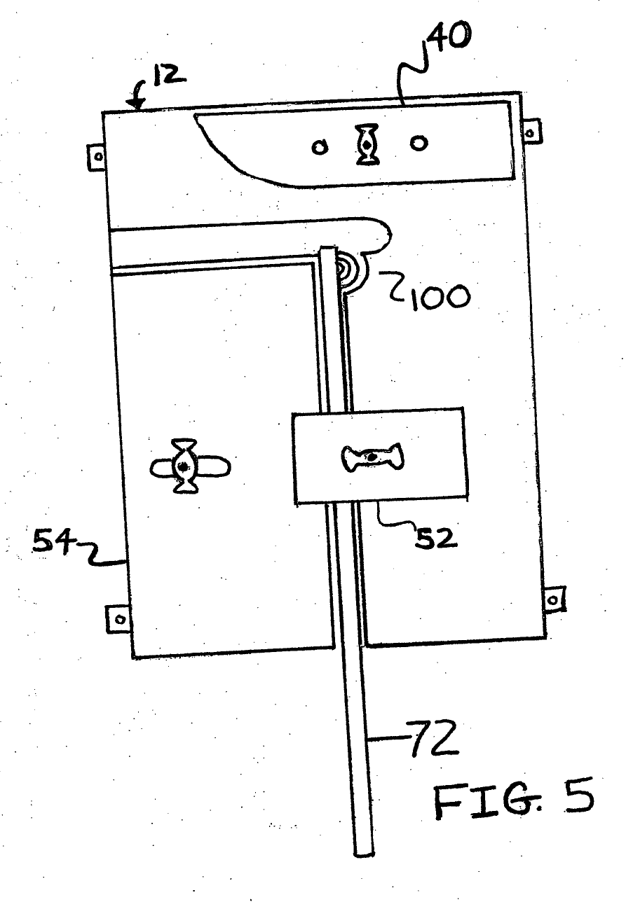

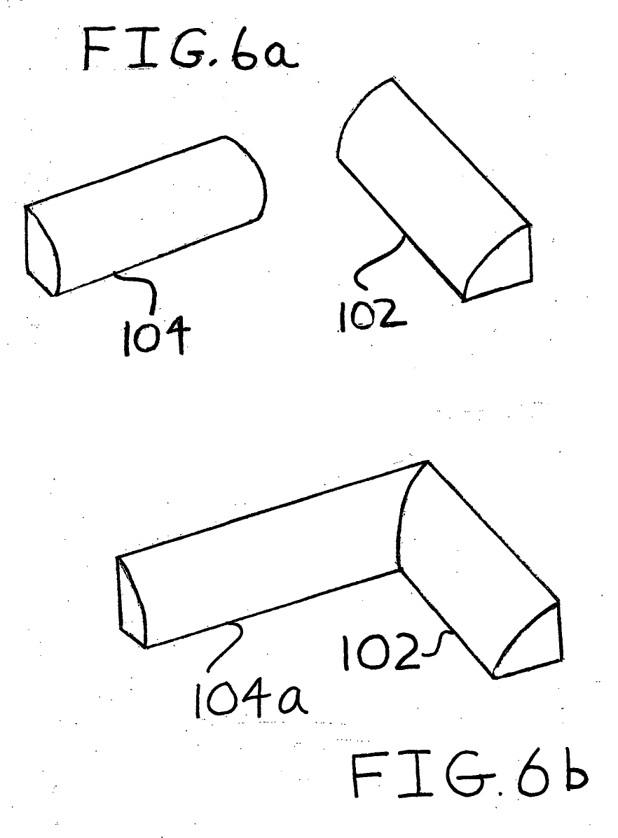

FIG. 5 illustrates, in plan view, a quarter-round piece of molding 72 clamped onto work area 8 in position for coping using a hole saw that is typically attached to an electric drill. To begin the procedure of coping using a hole saw, the hole saw is held by the work worker with cutting member of the hole saw positioned over and pointing toward aperture 28, which is adapted to receive and guide the extension rod of the hole saw as the saw cuts the work piece. FIG. 6a illustrates two pieces of uncoped quarter-round shoe molding intended for use as floor corner finishing trim, for example where section 104 will be coped to fit over and on section 102. FIG. 6b shows precisely coped section 104a fitted over and on section 102.

The use of the coping jig of the present invention is best illustrated in FIG. 3 and FIG. 5. FIG. 3 shows a piece of 2¼ inch base board molding in place for coping using a jig saw. Molding 70 is positioned on work area 8 between clamping means 54 and stopper edge 20. The end of the molding to be coped is positioned against the patterned edge surface of template 40. The molding is secured against lateral movement by clamping means 54 and stopper edge 20 and is prevented from moving vertically by clamping means 52. Once the work piece is securely positioned, the jig saw is placed into position so that as a worker is standing behind the jig saw, the right edge of the right jig saw foot is placed against the patterned edge surface of template 40. As the jig saw is moved forward toward molding 70, the blade 94 of the jig saw also moves forward. The jig saw continues to be urged forward in a direction that keeps the right edge of the right foot of the jug saw in contact with the patterned curve on the template. Thus, as the jig saw moves, the direction of the curve on the patterned edge surface is transferred to the motion of the jig saw and the jig saw blade so that the jig saw blade cuts the molding in a configuration conforming to the predetermined shape of the template.

To cope shoe molding (also referred to as quarter round) a hole saw is used instead of a jig saw. FIG. 5, as discussed above, illustrates a section of shoe molding in position for coping. To make the cut, the mandrel of the hole saw is positioned into aperture 28 and the saw blade is urged toward the aperture, and thus toward the molding, permitting the cup-like cutting blade of the hole saw to cope the shoe molding so that it fits precisely over a mating piece of shoe molding, as is illustrated in FIG. 6b.

The coping jig is easy for nearly everyone to use. The coping jig is also affordable to make and to purchase. It is contemplated that the coping jig be mass produced by any molding process, such as a plastic injection molding technique, although the jig could just as well be made of wood, metal, or fiberglass. The simplicity of the invention means that only the base of the coping jig, clamping means if not part of the base, and a desired template along with the cutting means of choice are required for repeated professional coping results. Using the coping jig of this invention means that even low-cost housing can be economically trimmed in a professional manner. It will be understood that although the invention has been described using a jig saw and a hole saw, a router could be used as well.

Thus it has been shown that the invention comprises a lightweight, portable coping jig that can quickly, efficiently, precisely, easily, and economically cope the ends of the work pieces, such as trim moldings, eliminating any need for the tedious repeated hand shaping and angling of the ends of molding to be fitted into a corner.

The foregoing description, for purposes of explanation, uses specific and defined nomenclature to provide a thorough understanding of the invention. However, it will be apparent to one skilled in the art that the specific details are not required in order to practice the invention. Thus, the foregoing descriptions of specific embodiments are presented for purposes of illustration and description. They are not intended to be exhaustive or to limit the invention to the precise forms disclosed. Those skilled in the art will recognize that many changes may be made to the features such as shape, color, materials, other embodiments, and methods of making the embodiments of the invention described herein without departing from the spirit and scope of the invention. Furthermore, the present invention is not limited to the described methods, embodiments, features or combinations of features but includes all the variation, methods, modifications, and combinations of features within the scope of the appended claims. The invention is limited only by the claims.

1. A jig for cutting a work piece in a configuration conforming to a predetermined shape, comprising:
a) a base, comprising:
i) a first surface area defining:
a work area adapted to receive a work piece, and
an opening for receiving a cutting means, and
ii) a second surface area comprising at least one template holding means adapted to receive at least one template;
b) at least one clamping means for releasably securing said work piece on said work area;
wherein said at least one template holding means detachably attaches at least one template thereto, wherein the direction of movement of the cutting means guided by said template is transferred to the direction of movement of a cutting member of the cutting means, thereby cutting said work piece to conform to said predetermined shape.

2. The coping jig, as recited in claim 2, wherein said clamping means for securing a work piece on said work area of said base, further comprises:
a) a first clamping means, and
b) a stopper edge;
wherein said first clamping means is slidably attached to said first surface area of said base;
wherein said stopper edge is defined by the junction between the first base surface area and the second base surface area;
said first clamping means and said stopper edge being oppositely disposed at opposite lateral sides of said work area to cooperatively securely position differently sized work pieces on said work area.

3. The coping jig, as recited in claim 1, wherein said clamping means for securing a work piece on said work area of said base, further comprises:
a second clamping means rotably attached to said second base surface area, said second clamping means adapted for securing the work piece in a vertical direction.

4. The coping jig, as recited in claim 1, wherein said cutting means further comprises a jig saw.

5. The coping jig, as recited in claim 1, wherein said cutting means further comprises a hole saw.

6. The coping jig, as recited in claim 1, wherein said cutting means further comprises a router.

7. The coping jig, as recited in claim 1, wherein said coping jig is made by molding.

8. The coping jig, as recited in claim 1, wherein said coping jig is made by casting.

9. The coping jig, as recited in claim 1, wherein said coping jig is made of wood.

10. The coping jig, as recited in claim 1, further comprising means for attaching said jig to a supporting surface.

11. A lightweight, portable, molded coping jig for cutting a work piece in a configuration conforming to a predetermined shape, comprising:
a) a base, comprising:
i) a first surface area defining:
a work area adapted to receive a work piece, and
an opening for receiving a cutting means, and
ii) a second surface area comprising at least one template holding means adapted to receive at least one template;
b) at least one clamping means for releasably securing said work piece on said work area;
wherein said at least one template holding means detachably attaches at least one template thereto, wherein the direction of movement of the cutting means guided by said template is transferred to the direction of movement of a cutting member of the cutting means, thereby cutting said work piece to conform to said predetermined shape.

12. The coping jig, as recited in claim 2, wherein said clamping means for securing a work piece on said work area of said base, further comprises:
a) a first clamping means, and
b) a stopper edge;
wherein said first clamping means is slidably attached to said first surface area of said base;
wherein said stopper edge is defined by the junction between the first base surface area and the second base surface area;
said first clamping means and said stopper edge being oppositely disposed at opposite lateral sides of said work area to cooperatively securely position differently sized work pieces on said work area.

13. The coping jig, as recited in claim 1, wherein said clamping means for securing a work piece on said work area of said base, further comprises:
a second clamping means rotably attached to said second base surface area, said second clamping means adapted for securing the work piece in a vertical direction.

14. The coping jig, as recited in claim 1, wherein said cutting means further comprises a jig saw.

15. The coping jig, as recited in claim 1, wherein said cutting means further comprises a hole saw.

16. The coping jig, as recited in claim 1, wherein said cutting means further comprises a router.

17. The coping jig, as recited in claim 1, wherein said coping jig is made by molding.

18. The coping jig, as recited in claim 1, wherein said coping jig is made by casting.

19. The coping jig, as recited in claim 1, wherein said coping jig is made of wood.

20. An apparatus for cutting an end of a shaped work piece, said cut end having substantially the mirror image shape of the cross-section contours of said shaped work piece, comprising:
a) a work piece support means adapted to receive a cutting means having a work piece cutting member;
b) at least one anchoring and positioning means for releasably securing said work piece onto said support means for cutting;
c) at least one template having a guide surface with a guide surface contour, wherein said cutting means having a work piece cutting member is guided by said template guide surface to cut said work piece to a predetermined shape.
